(19) United States
(12) Patent Application Publication
(10) Pub. No.: US 2025/0343785 A1
(43) Pub. Date: Nov. 6, 2025

(54) MULT-SERVICE ATTESTATION-BASED PASSKEY SERVICE PROVISION METHOD AND APPARATUS FOR IMPLEMENTING THE SAME

(71) Applicant: SAMSUNG SDS CO., LTD., Seoul (KR)

(72) Inventors: Dong Ho KIM, Seoul (KR); Hong Chul LEE, Seoul (KR); Si Wan BAE, Seoul (KR)

(73) Assignee: SAMSUNG SDS CO., LTD., Seoul (KR)

(21) Appl. No.: 19/188,626

(22) Filed: Apr. 24, 2025

(30) Foreign Application Priority Data
May 2, 2024 (KR) 10-2024-0058438

(51) Int. Cl. H04L 9/40

(52) U.S. Cl. CPC H04L 63/062; H04L 63/0823

(57) ABSTRACT

The present disclosure according to at least one embodiment provides a multi-service attestation-based passkey service provision method performed by a computing device. The method comprises when there exists a request from a first service server, among a plurality of service servers that respectively provide services to a user terminal, for generating a first service attestation for security authentication of a first service, obtaining a first intermediate certificate generated by signing information included in the request using a root certificate previously registered in a server, obtaining the first service attestation generated by signing the first intermediate certificate using a private key stored in the first service server, and transmitting the first service attestation to the server.

### CROSS-REFERENCE TO RELATED APPLICATION

This application claims priority from Korean Patent Application No. 10-2024-0058438 filed on May 2, 2024, in the Korean Intellectual Property Office, and all the benefits accruing therefrom under 35 U.S.C. 119, the contents of which in its entirety are herein incorporated by reference.

### BACKGROUND

### 1. Field

The present disclosure relates to a multi-service attestation-based passkey service provision method and an apparatus for implementing the same, and more specifically, to a multi-service attestation-based passkey service provision method for offering an authentication method with enhanced security for each individual service used by a user, and an apparatus for implementing the same.

### 2. Description of the Related Art

Conventional password-based user authentication has the drawback that passwords can be easily forgotten, require periodic changes, and are vulnerable to security threats.

To address the problems associated with password-based user authentication methods, there is increasing interest in passkey services, which offer passwordless user account authentication through Fast Identity Online (FIDO), a more convenient alternative.

Meanwhile, attestation refers to a certificate and key that exist in a secure area of a device. Conventionally, only one attestation is stored in a device, and resides in the authenticator within the device.

In such cases, since the private key of the attestation must be stored within the device, a security vulnerability exists in that the private key may be exposed in memory.

Furthermore, in a device environment where a passkey service is provided, using a single attestation stored in each device to authenticate multiple services provided through different service applications is not appropriate.

In addition, in a mobile device that supports FIDO2, only Google or Apple can be used as an authenticator, and therefore separate attestations for different services cannot be used.

Accordingly, when providing a passkey service, it is necessary to use an authentication method that employs individual attestations for service, provided through multiple service applications, rather than relying on a single attestation stored in each device.

Moreover, the attestation used to authenticate one service needs to be secured such that it is not exposed when authenticating other services.

### SUMMARY

An objective of the present disclosure is to provide a multi-service attestation-based passkey service provision method that enables the use of individual attestations for each service, and an apparatus for implementing the multi-service attestation-based passkey service provision method.

Another objective of the present disclosure is to provide a multi-service attestation-based passkey service provision method that offers a security management function through a separate server, rather than through each device, ensuring that the attestation used for authenticating one service is not exposed when authenticating other services, and an apparatus for implementing the multi-service attestation-based passkey service provision method.

Yet another objective of the present disclosure is to provide a multi-service attestation-based passkey service provision method that can meet the security requirements of customers for each individual service by using separate attestations, and an apparatus for implementing the multi-service attestation-based passkey service provision method.

The objectives of the present disclosure are not limited to those mentioned above, and other objectives not explicitly stated will be clearly understood by those skilled in the art based on the following description.

According to an aspect of the present disclosure, there is provided a multi-service attestation-based passkey service provision method performed by a computing device. The method comprises when there exists a request from a first service server, among a plurality of service servers that respectively provide services to a user terminal, for generating a first service attestation for security authentication of a first service, obtaining a first intermediate certificate generated by signing information included in the request using a root certificate previously registered in a server, obtaining the first service attestation generated by signing the first intermediate certificate using a private key stored in the first service server, and transmitting the first service attestation to the server.

In some embodiments, the server may be a passkey provider server that manages a passkey for user authentication of the first service.

In some embodiments, the obtaining of the first intermediate certificate may comprise delivering the request, received from the first service server, to the passkey provider server, the request including certificate information for generating the first service attestation, and receiving the first intermediate certificate generated by signing the certificate information included in the request using the root certificate stored in the passkey provider server, from the passkey provider server.

In some embodiments, the obtaining of the first service attestation may comprise delivering the first intermediate certificate to the first service server, and receiving, from the first service server, the first service attestation generated by signing the first intermediate certificate using a private key previously stored in the first service server.

In some embodiments, the obtaining of the first intermediate certificate may comprise storing the first intermediate certificate.

In some embodiments, the obtaining of the first service attestation may comprise registering the private key used to sign the first service attestation.

In some embodiments, the first service attestation may be stored and managed in the passkey provider server.

According to another aspect of the present disclosure, there is provided a multi-service attestation-based passkey service provision method performed by a computing device.

The method comprises when a passkey for user authentication of a first service is generated, receiving a verification request including a previously issued first service attestation for security authentication of the first service, and performing verification of the first service attestation using a previously stored first intermediate certificate.

In some embodiments, the receiving of the verification request including the previously issued first service attestation may comprise, when the passkey is generated by a passkey provider server in response to a passkey generation request from a first service server that provides the first service, among a plurality of service servers that respectively provide services to a user terminal, receiving, from the first service server via the user terminal, a response message including the first service attestation stored in the passkey provider server.

In some embodiments, the performing of the verification of the first service attestation may further comprise: when the verification of the first service attestation is successful, performing verification of the first intermediate certificate using a root certificate stored in the passkey provider server; and when the verification of the first intermediate certificate is successful, performing verification of the root certificate.

In some embodiments, the performing of the verification of the first service attestation may comprise, when the verification of the first service attestation fails, identifying the first service attestation as not being a certificate that matches the first service.

According to another aspect of the present disclosure, there is provided a multi-service attestation-based passkey service provision method performed by a computing device. The method comprises: when there exists a request from a first service server, among a plurality of service servers that respectively provide services to a user terminal, for generating a first service attestation for security authentication of a first service, generating a first intermediate certificate by signing information included in the request using a previously registered root certificate, delivering the first intermediate certificate to a passkey server connected with the first service server, receiving, from the passkey server, the first service attestation generated by signing the first intermediate certificate using a private key stored in the first service server, and storing the received first service attestation in association with the first service.

In some embodiments, the method may further comprises storing service attestations corresponding to the respective services provided by the plurality of service servers in association with the respective services.

According to another aspect of the present disclosure, there is provided a computing device comprising: at least one processor, a memory that loads a computer program executed by the at least one processor, and a storage that stores the computer program, wherein the computer program includes instructions for performing operations of: when there exists a request from a first service server, among a plurality of service servers that respectively provide services to a user terminal, for generating a first service attestation for security authentication of a first service, obtaining a first intermediate certificate generated by signing information included in the request using a root certificate previously registered in a server, obtaining the first service attestation generated by signing the first intermediate certificate using a private key stored in the first service server, and transmitting the first service attestation to the server.

In some embodiments, the server may be a passkey provider server that manages a passkey for user authentication of the first service.

In some embodiments, the obtaining of the first intermediate certificate may comprise: delivering the request, received from the first service server, to the passkey provider server, the request including certificate information for generating the first service attestation; and receiving, from the passkey provider server, the first intermediate certificate generated by signing the certificate information included in the request using a root certificate stored in the passkey provider server.

In some embodiments, the obtaining of the first service attestation may comprise delivering the first intermediate certificate to the first service server; and receiving, from the first service server, the first service attestation generated by signing the first intermediate certificate using a private key previously stored in the first service server.

In some embodiments, the obtaining of the first intermediate certificate may comprise storing the first intermediate certificate.

In some embodiments, the obtaining of the first service attestation may comprise registering the private key used to sign the first service attestation.

In some embodiments, the first service attestation may be stored and managed in the passkey provider server.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing exemplary embodiments in detail with reference to the attached drawings, in which:

FIG. 1 is a block diagram illustrating the configuration of a system for providing a passkey service based on multi-service attestation according to an embodiment of the present disclosure;

FIG. 2 is a flowchart illustrating a multi-service attestation-based passkey service provision method according to an embodiment of the present disclosure;

FIG. 3 is a flowchart illustrating a multi-service attestation-based passkey service provision method according to another embodiment of the present disclosure;

FIG. 4 is a flowchart illustrating a multi-service attestation-based passkey service provision method according to another embodiment of the present disclosure;

FIG. 5 illustrates the configuration of an overall system for issuing a service attestation according to some embodiments of the present disclosure;

FIG. 6 illustrates a flow of operations among devices for issuing a service attestation with reference to FIG. 5;

FIG. 7 illustrates the configuration of an overall system for verifying a service attestation according to some embodiments of the present disclosure;

FIG. 8 illustrates a flow of operations among devices for verifying a service attestation with reference to FIG. 7;

FIG. 9 illustrates an overall certificate chain structure for issuing and verifying a service attestation according to some embodiments of the present disclosure; and

FIG. 10 is a hardware configuration diagram of an exemplary computing device capable of implementing methods according to embodiments of the present disclosure.

### DETAILED DESCRIPTION

Hereinafter, preferred embodiments of the present disclosure will be described with reference to the attached drawings. The advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, some embodiments of the present disclosure will be described in detail with reference to the accompanying drawings.

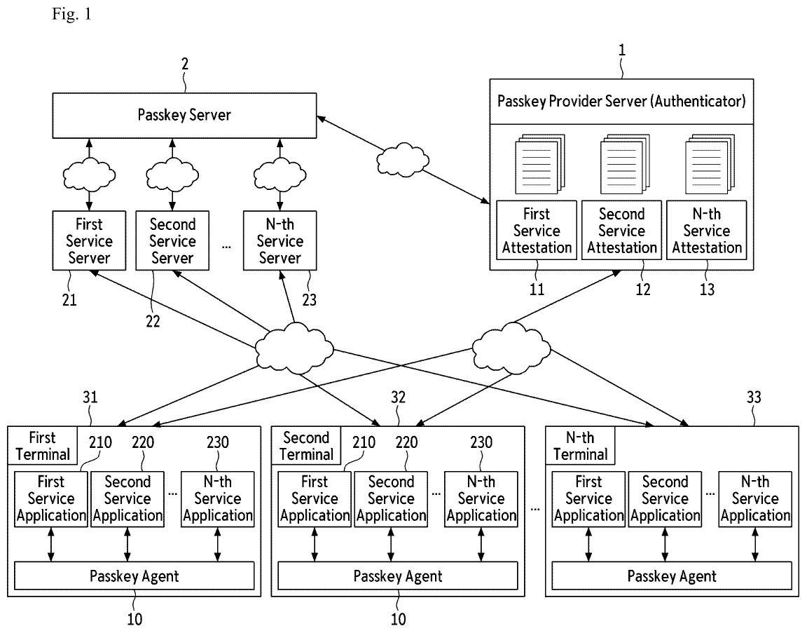

FIG. 1 is a block diagram illustrating the configuration of a system for providing a passkey service based on multi-service attestation according to an embodiment of the present disclosure.

Referring to FIG. 1, the system for providing a multi-service attestation-based passkey service according to an embodiment of the present disclosure includes a passkey provider server 1, a passkey server 2, a plurality of service servers 21, 22, . . . , 23, and a plurality of user terminals 31, 32, . . . , 33. The passkey provider server 1 is connected via a network to the passkey server 2 and the plurality of user terminals 31, 32, . . . , 33, and the plurality of service servers 21, 22, . . . , 23 are connected via a network to the plurality of user terminals 31, 32, . . . , 33. The passkey server 2 is connected via a network to the plurality of service servers 21, 22, . . . , 23.

Each of the plurality of user terminals 31, 32, . . . , 33 is a user terminal in which a passkey agent 10 providing a passkey service is installed to enable passwordless user authentication when performing login on a website via a browser or in each of the service applications 210, 220, . . . , 230. The plurality of user terminals 31, 32, . . . , 33 may be mobile terminals such as smartphones or tablets, or PCs. The plurality of user terminals 31, 32, . . . , 33 may be terminals operating on OS platforms such as Android, IOS, Windows, or macOS.

The plurality of service servers 21, 22, . . . , 23 are devices that provide necessary data and executable files for services offered through the plurality of service applications 210, 220, . . . , 230 installed on the plurality of user terminals 31, 32, . . . , 33, respectively. The plurality of service servers 21, 22, . . . , 23 may be, for example, application servers, cloud servers, or virtual servers.

The passkey provider server 1 is a device that receives and processes requests for passkey generation or passkey authentication from the plurality of user terminals 31, 32, . . . , 33. The passkey provider server 1 may be implemented as an application server, cloud server, or virtual server.

The passkey provider server 1 processes passkey generation requests or passkey authentication requests received from the passkey agents 10 installed in the plurality of user terminals 31, 32, . . . , 33, based on login requests from the corresponding service applications 210, 220, . . . , 230 or websites. In addition, the passkey provider server 1 provides information regarding passkeys installed in the plurality of user terminals 31, 32, . . . , 33 to the passkey agents 10 and performs a passkey management function in cooperation with the passkey agents 10.

The passkey server 2 transmits and receives messages and data with the passkey provider server 1 and the plurality of service servers 21, 22, . . . , 23, to issue service attestations for security authentication of services provided by the plurality of service servers 21, 22, . . . , 23, upon request from the respective service servers 21, 22, . . . , 23. The passkey server 2 may be implemented as an application server, cloud server, or virtual server.

When the service attestations corresponding to the respective services are issued, the passkey server 2 sends the issued service attestations to the passkey provider server 1, and the passkey provider server 1 registers the service attestations by associating them with the respective services provided by the plurality of service servers 21, 22, . . . , 23.

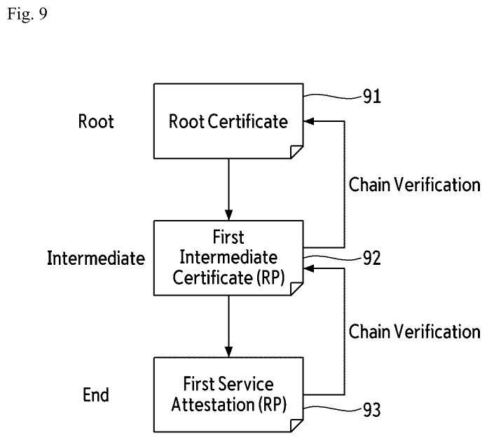

Additionally, after passkeys for user authentication of the respective services are generated, the passkey server 2 processes a verification request for the previously issued service attestations of the respective services. In this case, the passkey server 2 performs the verification process by using the certificate chain structure applied during the attestation issuance process in reverse (see FIG. 9).

Accordingly, the passkey server 2 can verify whether a service attestation issued for each service corresponds to the passkey generated for user authentication of the corresponding service.

That is, if the verification of a service attestation is successful, the service attestation is allowed to be used for secure authentication together with the corresponding service's passkey. If the verification fails, it is determined that the service attestation does not correspond to the service's passkey, and access and use are restricted to prevent exposure.

With the system configuration described above, it becomes possible to provide an authentication method that uses service attestations separated by service. In addition, by managing the service attestations in an integrated manner on a server, the security level can be improved by preventing the attestation used for authentication of one service from being exposed via the memory of each user terminal during the authentication of another service. Furthermore, by performing a verification process for service attestations when passkeys are generated, it is possible to strengthen security such that only attestations that pass verification are used for secure authentication of the corresponding services.

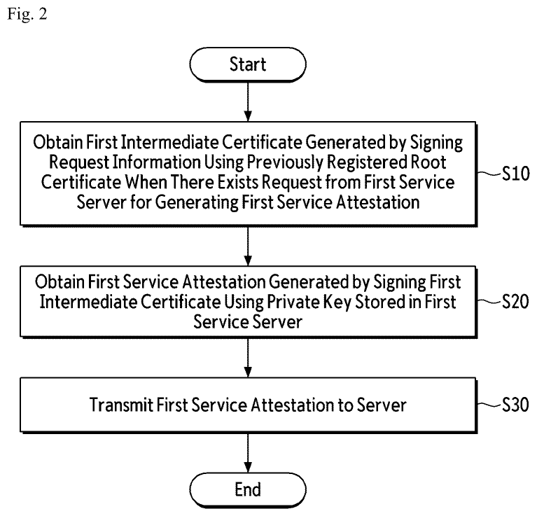

FIG. 2 is a flowchart illustrating a multi-service attestation-based passkey service provision method according to an embodiment of the present disclosure.

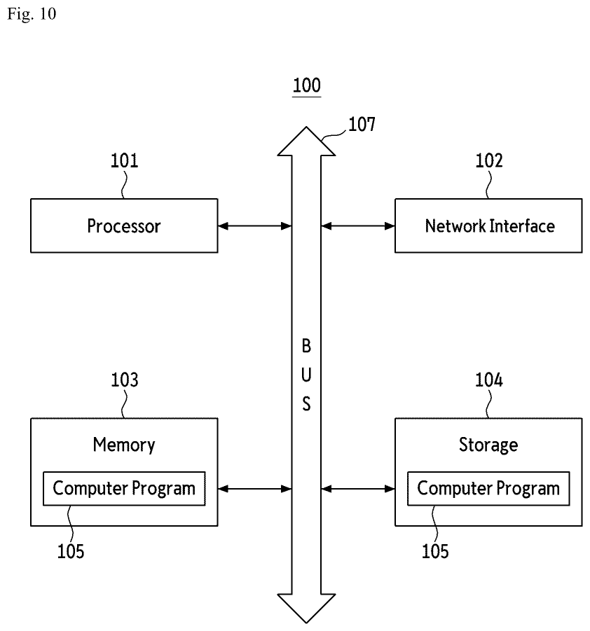

The multi-service attestation-based passkey service provision method according to an embodiment of the present disclosure may be executed by the passkey server 2 illustrated in FIG. 1 or by a computing device 100 illustrated in FIG. 10. The computing device 100 executing the multi-service attestation-based passkey service provision method according to an embodiment of the present disclosure may be a computing device equipped with an application program execution environment. The computing device 100 may be, for example, an application server, a cloud server, or a virtual server.

Descriptions of a subject entity that performs some operations or steps included in the multi-service attestation-based passkey service provision method according to an embodiment of the present disclosure may be omitted. In such cases, the subject entity is to be understood as the computing device 100.

In providing a passkey service, the multi-service attestation-based passkey service provision method according to an embodiment of the present disclosure can enhance the security level by offering an authentication method that uses individual attestations separated by service.

Referring to FIG. 2, in step S10, when there exists a request from a first service server 21, among a plurality of service servers 21, 22, . . . , 23 that provide services to a user terminal 31, for generating a first service attestation for security authentication of a first service, a computing device 100 obtains a first intermediate certificate generated by signing certificate information in the request using a root certificate previously registered in a passkey provider server 1.

In one embodiment, the computing device 100 may transmit the request received from the first service server 21 to the passkey provider server 1. The request may include certificate information necessary for generating the first service attestation, such as information on an issuing authority, validity period, or the like.

The computing device 100 may receive, from the passkey provider server 1, the first intermediate certificate generated by signing the certificate information in the request using the root certificate previously stored in the passkey provider server 1.

The computing device 100 may store the first intermediate certificate received from the passkey provider server 1. The first intermediate certificate corresponds to the first service provided by the first service server 21, and the computing device 100 may store the first intermediate certificate in association with the first service.

Thereafter, in step S20, the computing device 100 obtains the first service attestation generated by signing the first intermediate certificate with a private key stored in the first service server 21.

In one embodiment, when the computing device 100 transmits the first intermediate certificate to the first service server 21, the first service server 21 may generate the first service attestation by signing the first intermediate certificate using the private key stored therein, and transmit the first service attestation to the computing device 100.

At this time, the computing device 100 may register the private key used to sign the first service attestation received from the first service server 21.

Finally, in step S30, the computing device 100 transmits the first service attestation to the passkey provider server 1. The transmitted first service attestation may be stored and managed in the passkey provider server 1. The passkey provider server 1 may store the first service attestation in association with the first service.

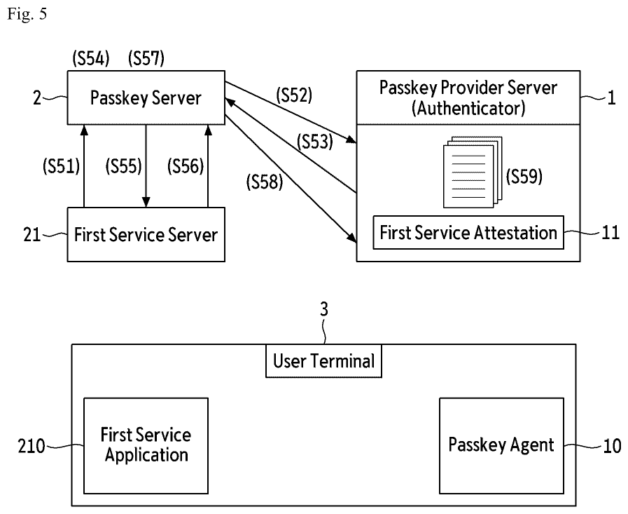

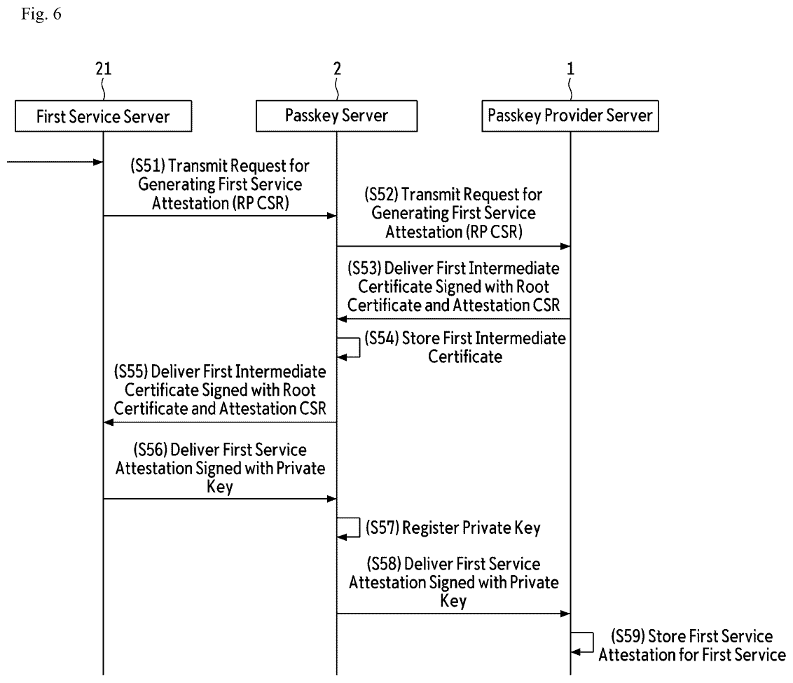

Steps S10, S20, and S30 in FIG. 2 will hereinafter be described in greater detail with reference to FIGS. 5 and 6.

FIG. 5 illustrates the configuration of an overall system for issuing a service attestation according to some embodiments of the present disclosure.

Referring to FIG. 5, during the issuance of a first service attestation 11 for security authentication of the first service provided by the first service server 21, the passkey server 2 transmits and receives request messages and data exchanged between the passkey provider server 1 and the first service server 21.

Specifically, referring to FIG. 6, when the first service server 21 transmits a first service attestation generation request to the passkey server 2 (S51), the passkey server 2 delivers the first service attestation generation request to the passkey provider server 1 (S52). At this time, the first service attestation generation request includes a Certificate Signing Request (CSR) that contains certificate generation information such as information on the issuing authority, validity period, etc.

The passkey provider server 1 generates a first intermediate certificate by signing the information included in the first service attestation generation request using a previously stored root certificate, and transmits the first intermediate certificate to the passkey server 2 (S53). At this time, the first intermediate certificate and the CSR are transmitted to the passkey server 2.

The passkey server 2 stores the first intermediate certificate received from the passkey provider server 1 (S54), and transmits the first intermediate certificate and the CSR to the first service server 21 (S55).

Accordingly, the first service server 21 generates the first service attestation 11 by signing the received first intermediate certificate using the private key previously stored therein and transmits the first service attestation 11 to the passkey server 2 (S56).

The passkey server 2 registers the private key included in the first service attestation 11 (S57), and transmits the first service attestation 11 to the passkey provider server 1 (S58).

Finally, the passkey provider server 1 stores the first service attestation 11 received from the passkey server 2 in association with the first service (S59).

According to this embodiment, by managing individual service attestations separated by service through servers when providing a passkey service, it is possible to meet the security requirements of customers for each service.

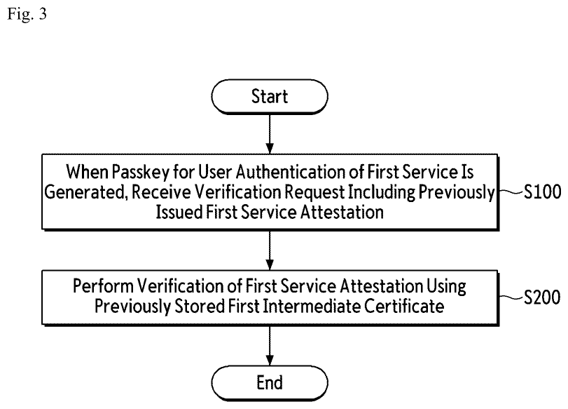

FIG. 3 is a flowchart illustrating a multi-service attestation-based passkey service provision method according to another embodiment of the present disclosure.

The multi-service attestation-based passkey service provision method according to another embodiment of the present disclosure may be executed by the passkey server 2 illustrated in FIG. 1 or the computing device 100 illustrated in FIG. 10. The computing device 100 executing the multi-service attestation-based passkey service provision method according to another embodiment of the present disclosure may be a computing device equipped with an application execution environment. The computing device 100 may be, for example, an application server, a cloud server, or a virtual server.

Descriptions of a subject entity performing some operations or steps included in the multi-service attestation-based passkey service provision method according to another embodiment of the present disclosure may be omitted. In such cases, the subject entity is to be understood as the computing device 100.

Steps S100 and S200 performed by the computing device 100 correspond to the verification of the first service attestation, and may be performed after the issuance of the first service attestation has been completed through steps S10, S20, and S30 of FIG. 2 as previously described.

Referring to FIG. 3, in step S100, when a passkey for user authentication of the first service is generated, the computing device 100 receives a verification request including a previously issued first service attestation for security authentication of the first service.

In one embodiment, when a passkey is generated by the passkey provider server 1 in response to a passkey generation request from the first service server 21, which provides the first service among the plurality of service servers 21, 22, . . . , 213 that respectively provide services to the user terminal 31, the computing device 100 may receive, from the first service server 21 via the user terminal 31, a response message including the first service attestation stored in the passkey provider server 1.

Thereafter, in step S200, the computing device 100 verifies the first service attestation using a previously store first intermediate certificate. If the verification of the first service attestation fails, the computing device 100 may identify the first service attestation as not being a certificate that matches the first service.

In one embodiment, if the verification of the first service attestation is successful, the computing device 100 may verify the first intermediate certificate using a root certificate stored in the passkey provider server 1. If the verification of the first intermediate certificate is also successful, the computing device 100 may finally verify the root certificate stored in the passkey provider server 1.

As such, the process of sequentially verifying the first service attestation (“93” in FIG. 9), the first intermediate certificate (“92” in FIG. 9), and the root certificate (“91” in FIG. 9) may be performed based on the certificate chain structure illustrated in FIG. 9.

That is, by applying the certificate chain structure illustrated in FIG. 9 to a service attestation issuance process, the computing device 100 (e.g., the passkey server 2) may generate the first intermediate certificate 92 signed with the root certificate 91 and the first service attestation 93 signed with a private key.

In addition, by applying the certificate chain structure illustrated in FIG. 9 in reverse to a service attestation verification process, the computing device 100 (e.g., the passkey server 2) may verify the first service attestation using the first intermediate certificate 92, verify the first intermediate certificate using the root certificate 91, and finally verify the root certificate 91.

At this time, the first intermediate certificate 92 may be applicable only to the first service provided by the first service server 21 among the plurality of service servers 21, 22, . . . , 23, and may be used to verify whether the first service attestation is intended for security authentication of the first service.

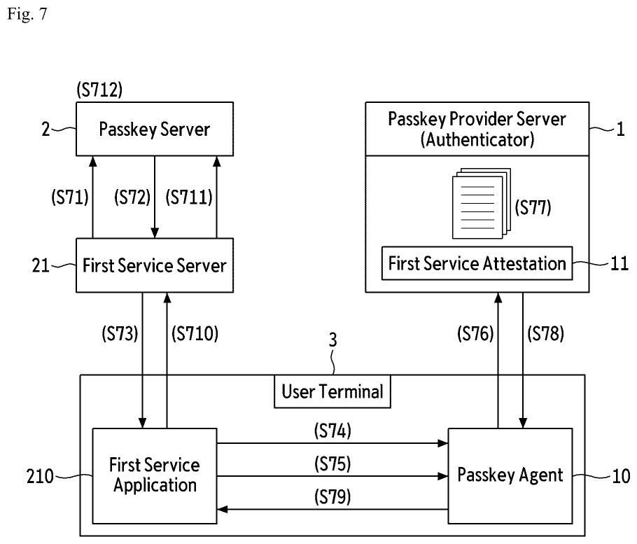

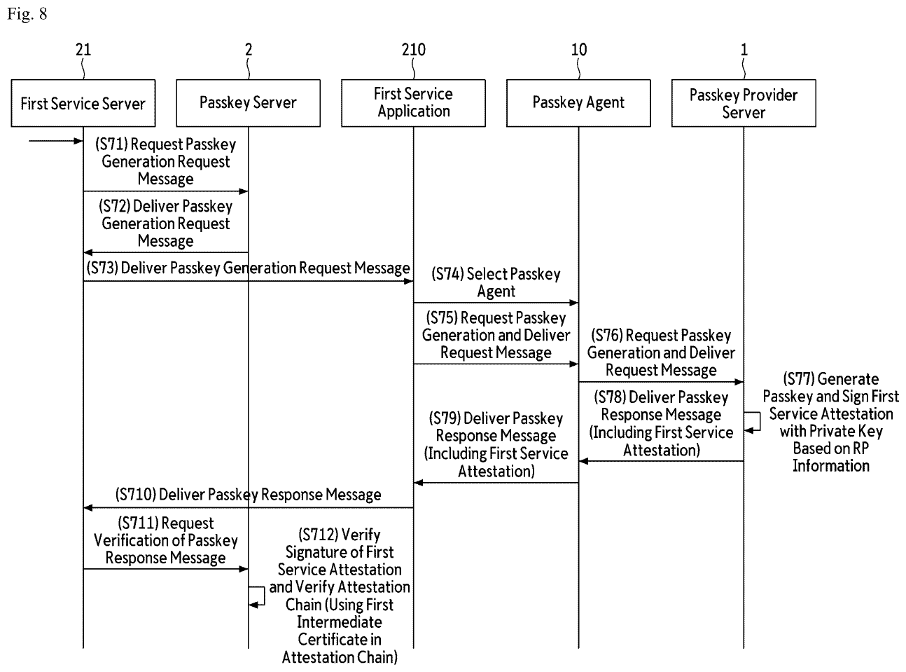

Steps S100 and S200 in FIG. 3 will hereinafter be described in greater detail with reference to FIGS. 7 and 8.

FIG. 7 illustrates the configuration of an overall system for verifying a service attestation according to some embodiments of the present disclosure.

Referring to FIG. 7, during the verification of the first service attestation 11, issued for security authentication of the first service provided by the first service server 21, the passkey server 2 transmits and receives request messages and data exchanged among the first service server 21, a user terminal 3, and the passkey provider server 1.

Specifically, referring to FIG. 8, when the first service server 21 sends a passkey generation request message to the passkey server 2 (S71), the passkey server 2 generates and delivers the passkey generation request message to the first service server 21 (S72).

Then, the first service server 21 delivers the passkey generation request message to a first service application 210 of the user terminal 3 (S73), and the first service application 210 selects a passkey agent 10 (S74) and delivers the passkey generation request message to the passkey agent 10 (S75).

When the passkey agent 10 delivers the passkey generation request message to the passkey provider server 1 (S76), the passkey provider server 1 generates a passkey based on the information regarding the first service (S77) and delivers a previous stored first service attestation 11 with a passkey response message to the passkey agent 10 (S78). Here, the passkey response message is generated in response to the passkey generation request message and may include, for example, the result of the passkey generation.

The passkey agent 10 delivers the first service attestation 11 and the passkey response message to the first service application 210 (S79), and the first service application 210 delivers the first service attestation 11 and the passkey response message to the first service server 21 (S710).

The first service server 21 transmits a verification request for the first service attestation, including the first service attestation 11 and the passkey response message, to the passkey server 2 (S711).

Accordingly, the passkey server 2 performs verification of the first service attestation 11 using a previously stored first intermediate certificate for the first service (S712). At this time, verification of the signature included in the first service attestation may be performed.

According to this embodiment, by performing a verification process for a service attestation when a passkey is generated, the security function can be enhanced such that only the attestation that passes verification can be used for security authentication of the corresponding service.

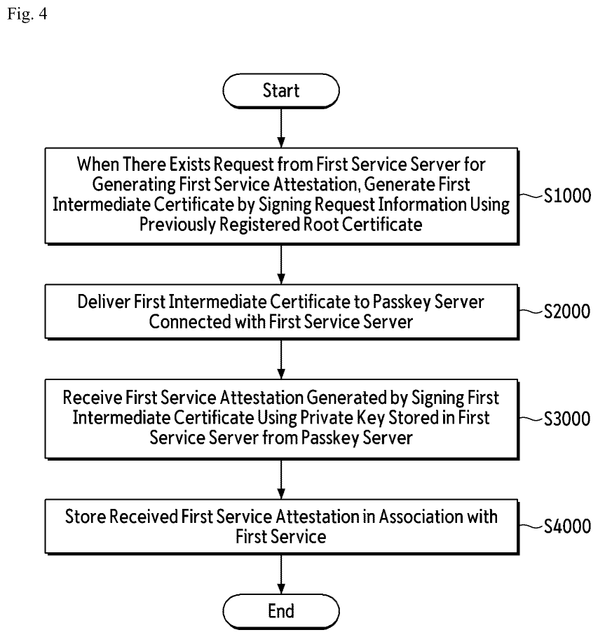

FIG. 4 is a flowchart illustrating a multi-service attestation-based passkey service provision method according to yet another embodiment of the present disclosure.

The multi-service attestation-based passkey service provision method according to yet another embodiment of the present disclosure may be executed by the passkey provider server 1 illustrated in FIG. 1 or the computing device 100 illustrated in FIG. 10. The computing device 100 executing the multi-service attestation-based passkey service provision method according to yet another embodiment of the present disclosure may be a computing device equipped with an application execution environment. The computing device 100 may be, for example, an application server, a cloud server, or a virtual server.

Descriptions of a subject entity performing some operations or steps included in the multi-service attestation-based passkey service provision method according to yet another embodiment of the present disclosure may be omitted. In such cases, the subject entity is to be understood as the computing device 100.

Referring to FIG. 4, in step S1000, when a request is received from the first service server 21, among the plurality of service servers 21, 22, . . . , 23 that respectively provide services to the user terminal 31, for generating a first service attestation for security authentication of the first service, the computing device 100 generates a first intermediate certificate by signing information included in the request using a previously registered root certificate.

Thereafter, in step S2000, the computing device 100 delivers the first intermediate certificate to the passkey server 2 connected with the first service server 21.

Thereafter, in step S3000, the computing device 100 receives, from the passkey server 2, a first service attestation generated by signing the first intermediate certificate using the private key stored in the first service server 21.

Finally, in step S4000, the computing device 100 stores the received first service attestation in association with the first service.

In one embodiment, the computing device 100 may store service attestations corresponding to the services provided by the plurality of service servers 21, 22, . . . , 23 in association with the respective services.

According to the aforementioned embodiments of the present disclosure, when providing a passkey service, it is possible to satisfy customers' security requirements for each service by using individual service attestations separated by service, and to more efficiently perform security management by managing the service attestations for each service in an integrated manner on a server.

FIG. 10 is a hardware configuration diagram of an exemplary computing device 100.

Referring to FIG. 10, the computing device 100 may include one or more processors 101, a bus 107, a network interface 102, a memory 103, which loads a computer program 105 executed by the processors 101, and a storage 104 for storing the computer program 105.

The processor 101 controls overall operations of each component of computing device 100. The processor 101 may be configured to include at least one of a Central Processing Unit (CPU), a Micro Processor Unit (MPU), a Micro Controller Unit (MCU), a Graphics Processing Unit (GPU), or any type of processor well known in the art. Further, the processor 101 may perform calculations on at least one application or program for executing a method/operation according to various embodiments of the present disclosure. The computing device 100 may have one or more processors.

The memory 103 stores various data, instructions and/or information. The memory 103 may load one or more programs 105 from the storage 104 to execute methods/operations according to various embodiments of the present disclosure. An example of the memory 103 may be a RAM, but is not limited thereto.

The bus 107 provides communication between components of computing device 100. The bus 107 may be implemented as various types of bus such as an address bus, a data bus and a control bus.

The network interface 102 supports wired and wireless internet communication of the computing device 100. The network interface 102 may support various communication methods other than internet communication. To this end, the network interface 102 may be configured to comprise a communication module well known in the art of the present disclosure.

The storage 104 can non-temporarily store one or more computer programs 105. The storage 104 may be configured to comprise a non-volatile memory, such as a Read Only Memory (ROM), an Erasable Programmable ROM (EPROM), an Electrically Erasable Programmable ROM (EEPROM), a flash memory, a hard disk, a removable disk, or any type of computer readable recording medium well known in the art.

In one embodiment, the computer program 105 may include instructions for performing the operations of: when there exists a request from a first service server, among a plurality of service servers that respectively provide services to a user terminal, for generating a first service attestation for security authentication of a first service, obtaining the first intermediate certificate generated by signing information included in the request using a root certificate previously registered in a server; obtaining the first service attestation generated by signing the first intermediate certificate using a private key stored in the first service server; and transmitting the first service attestation to the server.

In another embodiment, the computer program 105 may include instructions for performing the operations of: when a passkey for user authentication of a first service is generated, receiving a verification request including a previously issued first service attestation for security authentication of the first service; and performing verification of the first service attestation using a previously stored first intermediate certificate.

In yet another embodiment, the computer program 105 may include instructions for performing the operations of: when a request is received from a first service server, among a plurality of service servers that respectively provide services to user terminals, for generating a first service attestation for security authentication of a first service, generating a first intermediate certificate by signing the information included in the request using a previously registered root certificate; delivering the first intermediate certificate to a passkey server connected with the first service server; receiving, from the passkey server, the first service attestation generated by signing the first intermediate certificate using a private key stored in the first service server; and storing the received first service attestation in association with the first service.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A multi-service attestation-based passkey service provision method performed by a computing device, comprising:
when there exists a request from a first service server, among a plurality of service servers that respectively provide services to a user terminal, for generating a first service attestation for security authentication of a first service, obtaining a first intermediate certificate generated by signing information included in the request using a root certificate previously registered in a server;
obtaining the first service attestation generated by signing the first intermediate certificate using a private key stored in the first service server; and
transmitting the first service attestation to the server.

2. The multi-service attestation-based passkey service provision method of claim 1, wherein the server is a passkey provider server that manages a passkey for user authentication of the first service.

3. The multi-service attestation-based passkey service provision method of claim 2, wherein the obtaining of the first intermediate certificate comprises: delivering the request, received from the first service server, to the passkey provider server, the request including certificate information for generating the first service attestation; and receiving the first intermediate certificate generated by signing the certificate information included in the request using the root certificate stored in the passkey provider server, from the passkey provider server.

4. The multi-service attestation-based passkey service provision method of claim 1, wherein the obtaining of the first service attestation comprises: delivering the first intermediate certificate to the first service server; and receiving, from the first service server, the first service attestation generated by signing the first intermediate certificate using a private key previously stored in the first service server.

5. The multi-service attestation-based passkey service provision method of claim 1, wherein the obtaining of the first intermediate certificate comprises storing the first intermediate certificate.

6. The multi-service attestation-based passkey service provision method of claim 1, wherein the obtaining of the first service attestation comprises registering the private key used to sign the first service attestation.

7. The multi-service attestation-based passkey service provision method of claim 2, wherein the first service attestation is stored and managed in the passkey provider server.

8. A multi-service attestation-based passkey service provision method performed by a computing device, comprising:
when a passkey for user authentication of a first service is generated, receiving a verification request including a previously issued first service attestation for security authentication of the first service; and
performing verification of the first service attestation using a previously stored first intermediate certificate.

9. The multi-service attestation-based passkey service provision method of claim 8, wherein the receiving of the verification request including the previously issued first service attestation comprises, when the passkey is generated by a passkey provider server in response to a passkey generation request from a first service server that provides the first service, among a plurality of service servers that respectively provide services to a user terminal, receiving, from the first service server via the user terminal, a response message including the first service attestation stored in the passkey provider server.

10. The multi-service attestation-based passkey service provision method of claim 9, wherein the performing of the verification of the first service attestation comprises: when the verification of the first service attestation is successful, performing verification of the first intermediate certificate using a root certificate stored in the passkey provider server; and when the verification of the first intermediate certificate is successful, performing verification of the root certificate.

11. The multi-service attestation-based passkey service provision method of claim 8, wherein the performing of the verification of the first service attestation comprises, when the verification of the first service attestation fails, identifying the first service attestation as not being a certificate that matches the first service.

12. A multi-service attestation-based passkey service provision method performed by a computing device, comprising:
when there exists a request from a first service server, among a plurality of service servers that respectively provide services to a user terminal, for generating a first service attestation for security authentication of a first service, generating a first intermediate certificate by signing information included in the request using a previously registered root certificate;
delivering the first intermediate certificate to a passkey server connected with the first service server;
receiving, from the passkey server, the first service attestation generated by signing the first intermediate certificate using a private key stored in the first service server; and
storing the received first service attestation in association with the first service.

13. The multi-service attestation-based passkey service provision method of claim 12, further comprising:
storing service attestations corresponding to the respective services provided by the plurality of service servers in association with the respective services.

14. A computing device comprising:
at least one processor;
a memory that loads a computer program executed by the at least one processor; and
a storage that stores the computer program,
wherein the computer program includes instructions for performing operations of: when there exists a request from a first service server, among a plurality of service servers that respectively provide services to a user terminal, for generating a first service attestation for security authentication of a first service, obtaining a first intermediate certificate generated by signing information included in the request using a root certificate previously registered in a server; obtaining the first service attestation generated by signing the first intermediate certificate using a private key stored in the first service server; and transmitting the first service attestation to the server.

15. The computing device of claim 14, wherein the server is a passkey provider server that manages a passkey for user authentication of the first service.

16. The computing device of claim 15, wherein the obtaining of the first intermediate certificate comprises: delivering the request, received from the first service server, to the passkey provider server, the request including certificate information for generating the first service attestation; and receiving, from the passkey provider server, the first intermediate certificate generated by signing the certificate information included in the request using a root certificate stored in the passkey provider server.

17. The computing device of claim 14, wherein the obtaining of the first service attestation comprises: delivering the first intermediate certificate to the first service server; and receiving, from the first service server, the first service attestation generated by signing the first intermediate certificate using a private key previously stored in the first service server.

18. The computing device of claim 14, wherein the obtaining of the first intermediate certificate comprises storing the first intermediate certificate.

19. The computing device of claim 14, wherein the obtaining of the first service attestation comprises registering the private key used to sign the first service attestation.

20. The computing device of claim 15, wherein the first service attestation is stored and managed in the passkey provider server.
